(19) United States
(12) Patent Application Publication
(10) Pub. No.: US 2025/0373064 A1
(43) Pub. Date: Dec. 4, 2025

(54) DYNAMIC POWER SUPPLY

(71) Applicant: Apple Inc., Cupertino, CA (US)

(72) Inventors: Scott A. Jackson, Hampstead, NC (US); Mary I. Lopez, Phoenix, AZ (US); Ricardo Luis Janezic Pregitzer, San Jose, CA (US); Roshan Thakur, Fremont, CA (US); William O. Ferry, San Jose, CA (US)

(21) Appl. No.: 18/967,312

(22) Filed: Dec. 3, 2024

Related U.S. Application Data
(60) Provisional application No. 63/655,494, filed on Jun. 3, 2024.

(51) Int. Cl. H02J 7/04; H02J 7/00

(52) U.S. Cl. CPC H02J 7/04; H02J 7/0042; H02J 7/0047

(57) ABSTRACT

A dynamic power supply (e.g., a charger for a battery of an electronic device) may provide a higher power to fast charge the battery for a duration of time (e.g., a guaranteed duration of time), and a lower power (e.g., a less but guaranteed power, a standard power) after the duration of time. The dynamic power supply may enter this initial charging period if certain conditions are met, such as an operating characteristic is less than an initial charge operating characteristic threshold. After the initial charging period has elapsed, the dynamic power supply may enter a recovery period, where the dynamic power supply may supply the lower power, and/or supply a nominal or near zero power for a first time period and supply the higher power for a second time period.

### CROSS-REFERENCE TO RELATED APPLICATIONS

This application claims priority to U.S. Provisional Application No. 63/655,494, filed Jun. 3, 2024, which is incorporated by reference herein in its entirety.

### BACKGROUND

The present disclosure relates generally to power supplies, such as those used to supply power to electronic devices (e.g., mobile devices, cell phones, smartphones, wearable devices, tablets, laptop computers, desktop computers, and so on) and/or charge batteries (e.g., secondary or rechargeable batteries, lithium-ion batteries, lithium iron phosphate batteries, lithium-ion polymer batteries, nickel-cadmium batteries, nickel-metal hydride batteries, lead-acid batteries, etc.) in the electronic devices.

The batteries may be employed in a variety of consumer electronic applications. Certain batteries may be charged by “fast charging”: charging a battery at a power greater than a standard charging, such as greater than 5 watts (W), such as at 60 W. This may charge the batteries faster, which may be important to some users. However, due to the greater charging power of fast charging, physical dimensions of the power supply that may fast charge are also greater. Additionally, conventional fast charging power supplies may provide a constant amount of high power. Due to size constraints of the electronic devices, the devices may be thermally limited and thus only sustain high power levels for short durations of time. Further, the batteries may be charge-limited and also only sustain high power levels for short durations of time.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a device includes an outlet port, a connector port, and one or more sensors configured to determine a first operating characteristic and a second operating characteristic. The device also includes processing circuitry coupled to the outlet port, the connector port, and the one or more sensors. The processing circuitry is configured to supply a first power at the connector port based on the first operating characteristic and supply a second power at the connector port based on the second operating characteristic.

In another embodiment, a method includes determining, via one or more sensors of a dynamic power supply, a first operating characteristic. The method also includes supplying, via processing circuitry of the dynamic power supply, a first power to a power source of an electronic device based on the first operating characteristic. The method further includes determining, via the one or more sensors, a second operating characteristic. The method also includes supplying, via the processing circuitry, a second power to the power source based on the second operating characteristic.

In yet another embodiment, tangible, non-transitory, computer-readable media configured to store instructions that cause processing circuitry of a dynamic power supply to supply a first power based on a first operating characteristic of the dynamic power supply meeting a first threshold, and supply a second power based on a second operating characteristic of the dynamic power supply meeting a second threshold.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a plot illustrating a standard fast charging power supply (e.g., a fast charger) providing its high, constant power over a time period where an electronic device being charged by the fast charger is charged from 0% to 100% state of charge;

FIG. 2 is a plot illustrating a theoretical reduction in unused capability by a dynamic fast charging power supply (referred to herein as a “dynamic power supply”), according to embodiments of the present disclosure;

FIG. 3 is a plot illustrating a more realistic dynamic power supplied by a dynamic power supply, according to embodiments of the present disclosure;

FIG. 4 is a plot of behavior of the dynamic power supply based on an operating characteristic (e.g., temperature), according to embodiments of the present disclosure;

FIG. 5 is a plot of behavior of the dynamic power supply when average temperature of the dynamic power supply is below an operating temperature limit of the dynamic power supply, according to embodiments of the present disclosure;

FIG. 6 is a plot of hysteresis of the dynamic power supply, according to embodiments of the present disclosure;

FIG. 7 is a block diagram of a charging system including the dynamic power supply, according to embodiments of the present disclosure;

FIG. 8 is a perspective diagram of the charging system of FIG. 7, according to embodiments of the present disclosure; and

FIG. 9 is a flowchart of a method for dynamically charging a power source of an electronic device using the dynamic power supply, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to power supplies, such as those used to supply power to electronic devices (e.g., mobile devices, cell phones, smartphones, wearable devices, tablets, laptop computers, desktop computers, and so on) and/or charge batteries (e.g., secondary or rechargeable batteries, lithium-ion batteries, lithium iron phosphate batteries, lithium-ion polymer batteries, nickel-cadmium batteries, nickel-metal hydride batteries, lead-acid batteries, etc.) in the electronic devices. A battery may be charged by standard charging (e.g., at a power less than or equal to 5 watts (W)) or by “fast charging” (e.g., at a power greater than the standard charging, such as greater than 5 W). Fast charging may reduce a time to charge the battery, which may be important to some users. However, due to the greater charging power of fast charging, physical dimensions of a power supply capable of fast charging may also be greater. Additionally, conventional fast charging power supplies may provide a constant amount of high power. Due to size constraints of the electronic devices, the devices may be thermally limited and thus only sustain high power levels for short durations of time. Further, the batteries may be charge-limited and also only sustain high power levels for short durations of time.

As disclosed herein, a dynamic power supply (e.g., a charger for a battery of an electronic device) may provide a higher power to fast charge the battery for a duration of time (e.g., a guaranteed duration of time), and a lower power (e.g., a less but guaranteed power, a standard power) after the duration of time. For example, the dynamic power supply may provide a higher power of greater than 5 W (e.g., 60 W) for an initial charging period (e.g., 15 minutes), and then a lower power of less than or equal to 5 W for a recovery period. The dynamic power supply may enter this initial charging period if certain conditions are met, such as when a first operating characteristic (e.g., temperature) is less than a first initial charge operating characteristic threshold (e.g., 25° C.). After another set of conditions is met (e.g., a second operating characteristic, such as a time period, has elapsed), the dynamic power supply may enter the recovery period. In some embodiments, the dynamic power supply may supply the lower power (e.g., for at least a portion of or an entirety of the recovery period). In additional or alternative embodiments, the dynamic power supply may supply a nominal or near zero power, and then after certain conditions are met (e.g., a time period has elapsed), the dynamic power supply may supply the higher power. It should be understood that, during the recovery period, the dynamic power supply may supply any of the lower power, the higher power, and/or the nominal or near zero power, while maintaining the operating characteristic at less than or equal to a dynamic power supply operating characteristic threshold. After yet another set of conditions is met (e.g., a recovery operating characteristic, such as a recovery time period has elapsed), the dynamic power supply may return to providing the higher power for a new initial charging period. As another example, if the recovery operating characteristic has reached or is less than the first initial charge operating characteristic threshold, then the dynamic power supply may return to providing the higher power for a new initial charging period. In some embodiments, prior to supplying a change in power level, the dynamic power supply may wait for a hysteresis time period to elapse in order to avoid excessive back-and-forth communication with the electronic device.

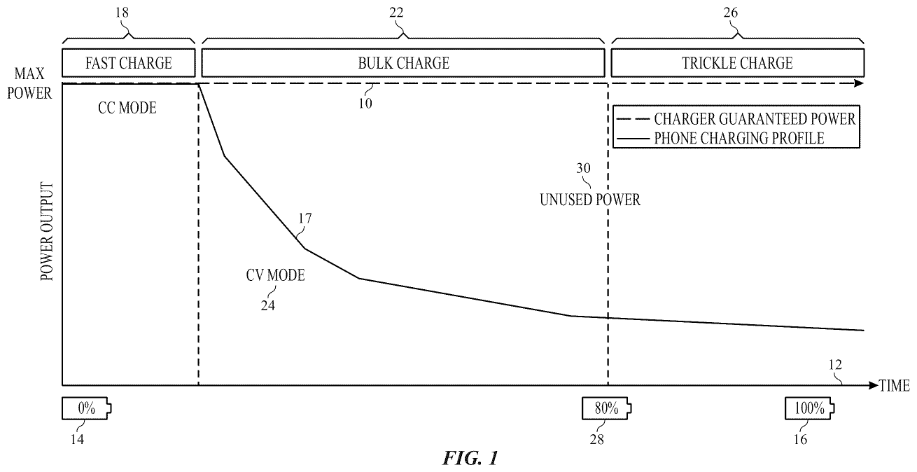

FIG. 1 is a plot illustrating a standard fast charging power supply (e.g., a fast charger) providing its high, constant power 10 (also referred to as “Max power” or “Charger Guaranteed Power”) over a time period 12 where a power source (e.g., a battery) of an electronic device being charged by the fast charger is charged from 0% state of charge (SoC) 14 to 100% SoC 16. As illustrated, a processor (e.g., power management integrated circuit (PMIC)) of the electronic device may increase or maximize a rate of charge of a charging profile 17 of the power source provided by the standard fast charger for a first period of time 18 (referred to as a “Fast Charge” period) by operating in a Constant Current (CC) mode 20, decrease the rate of charge of the charging profile 17 for a second period of time 22 (referred to as a “Bulk Charge” period) by operating in a Constant Voltage (CV) mode 24 (e.g., to protect or extend a lifetime of the power source and/or due to a thermal limitation or threshold of the electronic device), and further decrease the rate of charge of the charging profile 17 for a third period of time 26 (referred to as a “Trickle Charge” period) when the power source is charged at 80% SoC 28 (though, in other instances, the SoC when trickle charging begins may be any suitable SoC), such as when the power source or load reaches active power, such that the power source is charged at a rate equal to its self-discharge rate). As illustrated by the plot of FIG. 1, there is an amount of unused power 30, since a bulk of the high power provided by the standard fast charger is only needed for a short time for fast charging (i.e., during the Fast Charge period 18). As such, much of the high power is wasted over the time that the standard fast charger is coupled to the electronic device.

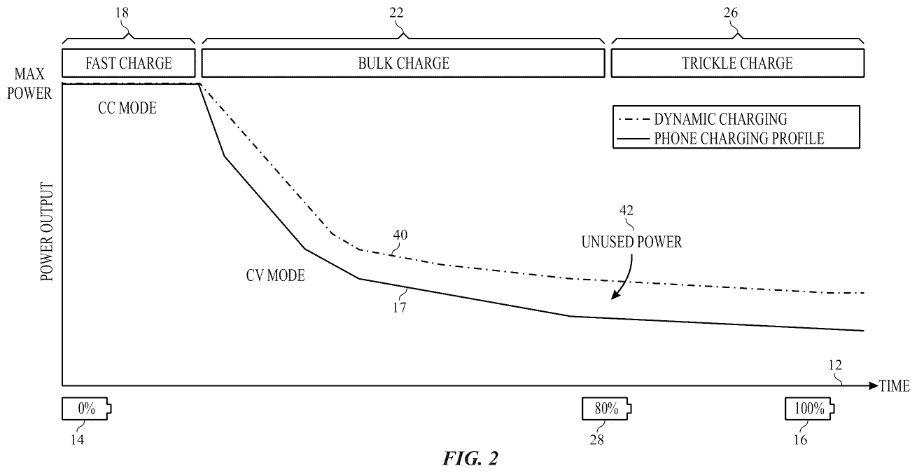

FIG. 2 is a plot illustrating a theoretical reduction in unused capability by a dynamic fast charging power supply (referred to herein as a “dynamic power supply”), according to embodiments of the present disclosure. In particular, dynamic charging 40 (e.g., a charging or power that is not constant) provided by the dynamic power supply may have less overall charging power over time, and thus may be reduced in power output, while providing the same charging experience, from the perspective of the power source electronic device, when compared to the constant power 10 provided by the charger referred to in FIG. 1. As illustrated, the dynamic charging 40 provided by the dynamic power supply may provide power that is slightly greater than (e.g., but less than the constant power 10 provided by the charger referred to in FIG. 1) or equal to the charging profile 17 of the electronic device. However, in some embodiments, providing this type of dynamic charge 40 that is constantly slightly greater than or equal to the charging profile 17 of the power source of the electronic device may not be practical. An amount of unused power 42 resulting from the dynamic charge 40 is shown to be much less than the unused power 30 resulting from the constant charge 10 of FIG. 1, since the dynamic charge 40 is closer, through time, to the charging profile 17.

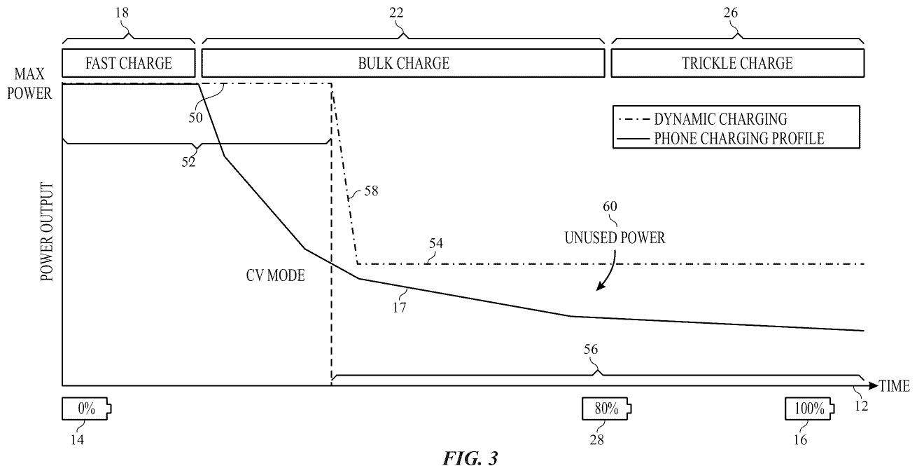

FIG. 3 is a plot illustrating a more realistic dynamic power supplied by the dynamic power supply, according to embodiments of the present disclosure. The dynamic power supply may provide a fast charge having a higher or maximum power 50 for a short duration of time 52, and a less but guaranteed power 54 (e.g., lower power, a standard power) for a remaining period of time 56 of the charging profile 17 of the power source for more standard charging. As illustrated, dynamic power 58 supplied by the dynamic power supply may include a predefined behavior (e.g., programmed into a memory of the dynamic power supply and executed by processing circuitry of the dynamic power supply) that includes step-wise behavior (e.g., providing a first power 50 for a first time period 52 and a second power 54 for a second time period 56). As a result, the dynamic power supply may achieve reduction in unused power 60 when compared to the unused power 30 resulting from using the standard charger of FIG. 1, thus reducing cost, electronic device waste, and size of the charger.

As noted above, the higher power 50 may include a maximum power that may be offered by the dynamic power supply and may last for a short duration of time 52. In some cases, the higher power 50 may be referred to as a “Port Maximum Power Delivery Power (PDP)” under the Universal Serial Bus-Power Delivery (USB-PD) standard. A present power provided by the dynamic power supply may dynamically change as the dynamic power supply is limited (e.g., as the power supplied changes between the higher power 50 and the lower power 54), but may never be less than the guaranteed, lower power 54. The present power may be referred to as a “Port Present PDP” under the USB-PD standard. It should be understood that, even though the dynamic power supply may supply at least the guaranteed, lower power 54, processing circuitry, such as a power management integrated circuit (PMIC) of an electronic device coupled to and being supplied power by the dynamic power supply may limit or reduce power used by the electronic device (e.g., further lowering or decreasing the power used from the guaranteed, lower power 54 supplied by the dynamic power supply).

The dynamic power supply may provide the higher power 50 for a time period 52 based on certain predetermined conditions or operating characteristics, and the lower power 54 guaranteed or indefinitely (e.g., for a remaining period of time 56). The operating characteristics may include any operating characteristic that may indicate that the lower power 54 should be provided. As such, the operating characteristics may include temperature, time, current, voltage, power, whether the dynamic power supply is directly (e.g., without any intervening or intermediate devices) coupled or mounted to an electrical or wall outlet (e.g., wall mounted), and so on. For example, an operating characteristic may include temperature (e.g., of the dynamic power supply, at an exterior or “skin” of the dynamic power supply, at an interior or circuit of the dynamic power supply, at the electronic device, of an ambient environment, and so on), such that the dynamic power supply may provide the higher power when and/or while the temperature is less than a threshold temperature or within a threshold temperature range, and once the temperature exceeds the threshold temperature or is outside the threshold temperature range, begins providing the lower power. The threshold temperature and/or the threshold temperature range may include any suitable temperature and/or temperature range that indicates that the lower power should be provided (e.g., 25° Celsius (C) or less, 25° C. or greater, 27° C. or greater, 30° C. or greater, and so on). In some embodiments, the dynamic power supply may begin providing the higher power 50 when the temperature is within the threshold temperature range, and continue providing the higher power 50 even if the temperature exceeds or exits the threshold temperature range for a threshold time (e.g., 10 minutes or less, 10 minutes or more, 15 minutes or more, 20 minutes or more, and so on).

Other operating characteristics may include an amount of input voltage (e.g., such that the higher power 50 may be provided when the input voltage is within a threshold range, such as between 100 volts alternating current (VAC) and 240 VAC), whether the dynamic power supply is connected or plugged in to a wall outlet, a time that the dynamic power supply has been supplying the higher power 50 to the electronic device, and so on. Moreover, the dynamic power supply may provide the higher power 50 based on any combination of any suitable operating characteristics.

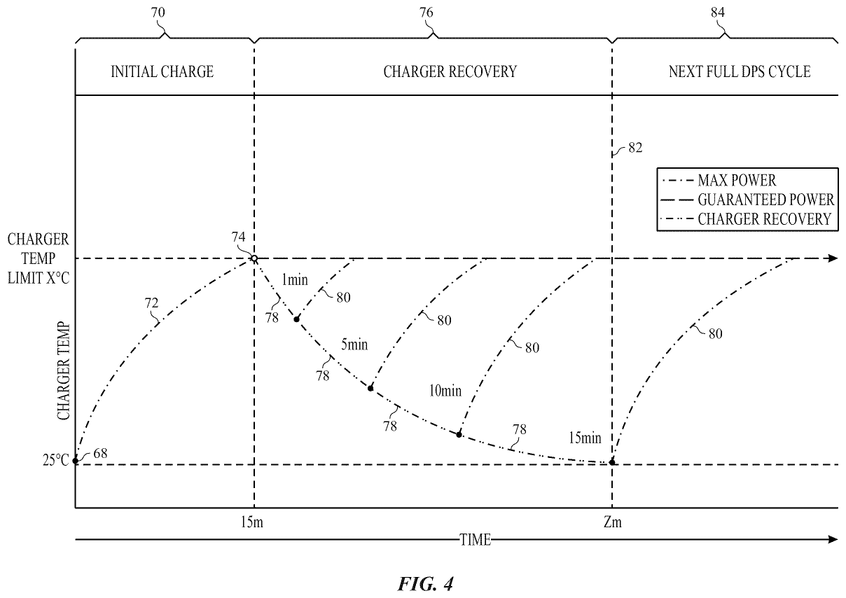

FIG. 4 is a plot of behavior of the dynamic power supply based on an operating characteristic (e.g., temperature), according to embodiments of the present disclosure. When a first operating characteristic condition or conditions (e.g., temperature of the dynamic power supply at or under a first or charging temperature threshold 68, such as 25° C.) are met, an initial charge period 70 (e.g., between 0 and 15 minutes) may begin, and the dynamic power supply supplies the higher power 50 (illustrated as “Max Power”) to the power source of the electronic device. The first operating characteristic condition may include a first operating characteristic meeting or exceeding a first operating characteristic threshold. The first operating characteristic may include temperature, time, current, voltage, power, whether the dynamic power supply is directly (e.g., without any intervening or intermediate devices) coupled or mounted to an electrical or wall outlet (e.g., wall mounted), and so on. As mentioned above, the electronic device may draw less power than that provided by the dynamic power supply, even though the dynamic power supply may provide the higher power 50 (or indeed any other power). During the initial charge period 70, the temperature rises 72 while the dynamic power supply supplies the higher power, until the temperature reaches a second or charger temperature threshold 74 (referenced as X° C.). It should be understood that, even though the plot shows that the temperature rises 72 in a curve, in other instances, the temperature may change (e.g., decrease), thus extending the time of the initial charge period 70. Indeed, the 15 minute period illustrated as the initial charge period 70 may be a minimum or guaranteed period of time that the dynamic power supply may provide the higher power 50 (as long as the operating characteristic conditions are initially met). As such, the 15 minute period may be referred to as a second operating characteristic condition or conditions. Moreover, it should be understood that the usage of 15 minutes for the initial charge period 70 is an example, and it is contemplated that any suitable time period may be used for the initial charge period 70 (e.g., 5 minutes or less, 10 minutes or less, 15 minutes or less, 20 minutes or less, 30 minutes or less, more than 30 minutes, and so on).

In some embodiments, when the temperature reaches the second temperature threshold 74 (at 15 minutes), the dynamic power supply may enter a charger recovery period or time 76. In such an example, exceeding or meeting the second temperature threshold 74 may be referred to as the second operating characteristic condition or conditions. In additional or alternative embodiments, the second operating characteristic may include any other suitable operating characteristic, in addition or in the alternative to temperature, such as time, current, voltage, power, whether the dynamic power supply is directly (e.g., without any intervening or intermediate devices) coupled or mounted to an electrical or wall outlet (e.g., wall mounted), and so on. As illustrated, in some embodiments, the dynamic power supply may provide the lower power 54 (illustrated as “Guaranteed Power”) over the duration of the charger recovery period 76. In additional or alternative embodiments, the dynamic power supply may enter a charger recovery state, in which the charger may be unplugged (e.g., by a user) or draw a nominal, near, or at zero power (e.g., a recovery power), causing the temperature of the dynamic power supply to decrease 78. After a time period (e.g., a predetermined time period), such as after 1 minute, 5 minutes, 10 minutes, and 15 minutes, the temperature of the dynamic power supply may decrease 78, and the dynamic power supply may supply the higher power 50, thus causing the temperature of the dynamic power supply to increase 80. It should be understood that any suitable time period for the dynamic power supply to return to supplying the higher power 50 from the recovery power is contemplated (e.g., after 1 minute or more, after 5 minutes or more, less than 1 minute, and so on). As illustrated, and in some embodiments, the dynamic power supply may stop supplying the higher power 50 once the second temperature threshold 74 is reached.

In some embodiments, the dynamic power supply may enforce a switching time delay or hysteresis (e.g., of 1 minute or less, 1 minute or more, 2 minutes or more, 5 minutes or more, and so on) where the dynamic power supply may not switch from providing one power level to another power level within the hysteresis time period. For example, the dynamic power supply may switch from providing the recovery power to the higher power 50, but may not switch back to providing the recovery power within the hysteresis time (e.g., 1 minute). This may limit or reduce an amount of back-and-forth communication between the dynamic power supply and the electronic device to increase or optimize efficiency between the devices. Additionally, this may apply to dynamic power supplies that are already at higher temperatures or operating characteristics due to a previous charging session (e.g., unplugging and plugging into a new electronic device). Moreover, in additional or alternative embodiments, the dynamic power supply may additionally or alternatively return to supplying the lower power 54 once an operating characteristic of the dynamic power supply reaches a recovery operating characteristic threshold. For example, as illustrated, the dynamic power supply may return to supplying the lower power 54 once the temperature of the dynamic power supply reaches another or recovery temperature threshold (e.g., at 25° C. or less, at 25° C. or more, at 30° C. or more, and so on). It should be understood that, during the recovery period, the dynamic power supply may supply any of the lower power 54, the higher power 50, and/or the recovery power (e.g., as set forth by a manufacturer of the dynamic power supply), while maintaining the operating characteristic at less than or equal to a dynamic power supply operating characteristic threshold.

When a recovery operating characteristic condition or conditions occurs, such as when one or more recovery operating thresholds are met by one or more recovery operating characteristics, a next full dynamic power supply (DPS) cycle 84 may begin. As with the first and second operating characteristics, the recovery operating characteristic may include temperature, time, current, voltage, power, whether the dynamic power supply is directly (e.g., without any intervening or intermediate devices) coupled or mounted to an electrical or wall outlet (e.g., wall mounted), and so on. For example, the recovery operating characteristic may include time. As such, after a recovery or third time threshold 82 (illustrated as Z minutes), which may be determined by a power supply power policy (e.g., as set forth by a manufacturer of the dynamic power supply), a next full dynamic power supply (DPS) cycle 84 may begin. The third time threshold 82 or the charger recovery period 76 may enable the dynamic power supply to provide the higher power 54 and/or fast charging for the initial charge period 70 or guaranteed time. As such, the third time threshold 82 may enable the operating characteristic to return to its original level prior to initial charging (e.g., to the first or charging temperature threshold 68). For example, in the case that the first initial operating characteristic is the temperature of the dynamic power supply, and the first initial operating characteristic threshold is the first temperature threshold 68 is 25° C., the charger recovery period 76 may enable the temperature of the dynamic power supply to return to 25° C. (e.g., if the dynamic power supply provides the recovery power during at least part of the recovery period 76). In some embodiments, the dynamic power supply may begin the next full dynamic power supply cycle when the temperature of the dynamic power supply reaches or is below the first temperature threshold 68.

As such, the dynamic power supply may supply power at different power levels based on temperature and/or time. Moreover, in some embodiments, each illustrated period (e.g., the initial charger period 70, the charger recovery period 76, the next full DPS cycle 84) may be triggered based on a detected temperature of the dynamic power supply, or a clock or timer of the dynamic power supply (e.g., where each power level is supplied for a predetermined duration of time), or a combination of the two.

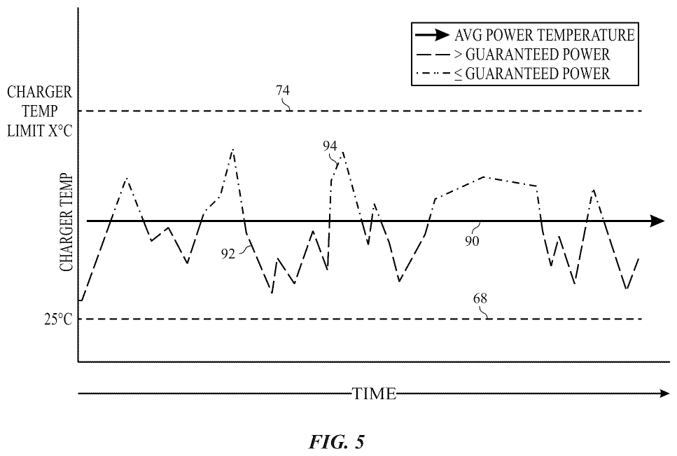

FIG. 5 is a plot of behavior of the dynamic power supply when average temperature of the dynamic power supply is below an operating temperature limit 74 of the dynamic power supply (e.g., the second temperature threshold 74), according to embodiments of the present disclosure. As discussed above, if the power drawn by the power source of the electronic device results in an average temperature 90 of the dynamic power supply being low enough to not reach the second or charger temperature threshold 74 (e.g., during the initial charge period 70), then the dynamic power supply may continue to provide the higher power 50 (e.g., a maximum power contract). As illustrated, the power source of the electronic device draws power at both less than 92 or equal to the lower or guaranteed power 54 supplied by the dynamic power supply and greater than 94 the lower power 54 for the illustrated time period, resulting in the illustrated average power temperature 90. Because the average power temperature 90 never reaches the second temperature threshold 74 (illustrated as charger temp limit X° C.), the dynamic power supply may continue to supply the higher power 50 and not switch to supplying the lower power 54. For example, during the charger recovery period 76, the dynamic power supply may provide the higher power 50 at some times and the lower power 54 at other times, thus providing a maximum power contract (e.g., a guaranteed delivery of the higher power 50 at a specific voltage and a specific current), if the average temperature 90 of the dynamic power supply is below the operating temperature limit 74 of the dynamic power supply.

As discussed above, the initial charge period 70 may be any suitable time period. However, in terms of performance, it may be advantageous to ensure that the power source of the electronic device reaches a 50% SoC from a 0% SoC in the time period. Moreover, it may also be advantageous to enable reaching the 50% SoC using a more commonly used charger cable (e.g., a 3 amp (A) charger cable) rather than a less ubiquitous charger cable (e.g., a 5 A charger cable). It is further noted that 20 volts (V) is often used for efficient charging, a direct current resistance (DCR) of a charger cable may be 200 milliohms (mΩ), and an internal efficiency of certain electronic devices (e.g., smartphones) may be approximately 85%. In such a case, to charge from 0% to 50% SoC, it may take approximately 15 minutes at a power of 49 W. As such, the time period for the initial charge period 70, where the dynamic power supply supplies the higher power 50, may be 15 minutes in some embodiments.

To enable the dynamic power supply described above, processing circuitry of the dynamic power supply may communicate with processing circuitry of the electronic device to exchange certain information. For example, the dynamic power supply may already provide (e.g., send or transmit) an indication of a maximum power level (e.g., the higher power 50) in a message (e.g., a Source Capabilities Extended message as set forth by the USB-PD standard, at offset 23) to the electronic device as set forth by the USB-PD standard. Likewise, the dynamic power supply may provide (e.g., send or transmit) an indication of a minimum power level (e.g., the lower or guaranteed power 54, Port Minimum PDP). In some embodiments, the dynamic power supply may use the same message to provide the minimum power level 54 (e.g., at a different portion or offset of the Source Capabilities Extended message, such as offset 25). As another example, an indication of the minimum power level 54 may be added as part of an additional Vendor Data Object (VDO) to the Source_Info Data Object (set forth by the USB-PD standard). Advantageously, legacy sink devices (e.g., those electronic devices that have not been updated to operate using an updated USB-PD standard that communicates the minimum power level of the dynamic power supply) would ignore this information and continue operating.

Additionally, the dynamic power supply may send or transmit an indication or an alert message to the electronic device before proceeding with a power reduction to warn the electronic device in advance. This may be the case when the dynamic power supply switches from supplying the higher power 50 to the lower power 54. There may be a minimum time between sending the alert message and reducing the power level (e.g., from the higher power 50 to the lower level 54), such as 1 second or less, 2 seconds or less, 5 seconds or less, 5 seconds or more, and so on. For example, the dynamic power supply may send an Alert Message, as set forth by the USB-PD standard, to the electronic device with a minimum of 2 seconds before reducing power (e.g., Source Capabilities as referred to by the USB-PD standard). This may enable the electronic device to adjust operation (e.g., pause or stop certain operations, offload certain tasks) to accommodate or compensate for the reduction of power. Legacy sink devices may ignore the extended alert message or, in some cases, for older revisions of the USB-PD standard, the dynamic power supply may not send the extended alert message at all.

As discussed above, a minimum amount of time (e.g., defining the initial charge period 70) for providing the higher power 50 (Port Maximum PDP) may be enforced as the second operating characteristic threshold (e.g., 15 minutes) for the dynamic power supply that is, at first use, where a first operating characteristic threshold is met (e.g., when an enclosure temperature of the dynamic power supply is at an ambient temperature of 25° C. 68). Additionally, a minimum amount of time (e.g., the hysteresis time, a minimum time between new Source Capabilities) may be enforced or guaranteed between new power supply capabilities (e.g., changing between a first power level and a second power level) related to the dynamic power supply to limit an amount of back-and-forth communication. Moreover, this may apply to dynamic power supplies that are already at higher temperatures or operating characteristics due to a previous charging session (e.g., unplugging and plugging into a new electronic device). For example, the dynamic power supply may implement or guarantee a hysteresis time of 1 minute between new Source Capabilities (raising or lowering Port Present PDP) to limit constant communications and power changing power in the electronic device (e.g., power sink). Further, the dynamic power supply may support voltages (e.g., all voltages) that are supported for the higher power 50 (the maximum PDP), even if the dynamic power supply is supplying the lower power 54, though this may apply (e.g., only apply) for dedicated power chargers. That is, even if the dynamic power supply is supplying the lower power 54, the dynamic power supply may nevertheless supply different (or all supported) voltages as set forth by the USB-PD standard (e.g., Mandatory Voltages) when supplying the higher power 50. For example, the dynamic power supply may offer all voltages required at Port Maximum PDP regardless of Port Present PDP.

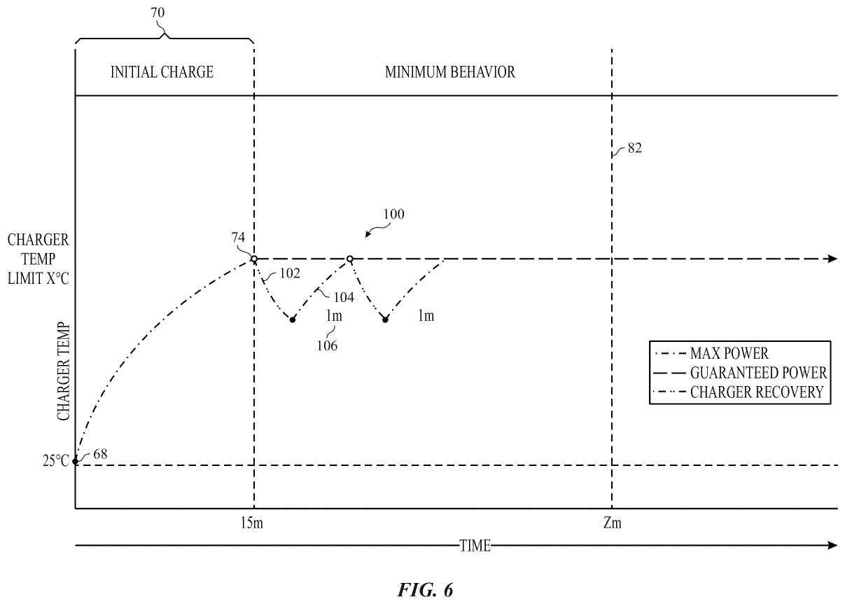

FIG. 6 is a plot of hysteresis of the dynamic power supply, according to embodiments of the present disclosure. In particular, during the charger recovery period 76, the dynamic power supply may perform based on a minimum behavior 100, where the dynamic power supply may provide the lower power 54 (e.g., at least for a portion or for the entirety of the charger recovery period 76, resulting in the charger temperature to remain at the charger temperature limit 74) and/or alternate between supplying the recovery power (e.g., to enable the operating characteristic or temperature of the dynamic power supply to decrease below 102 the dynamic power supply operating characteristic threshold 74 (“Charger Temp Limit X° C.”) and supplying the higher power 50 (e.g., causing the operating characteristic or temperature of the dynamic power supply to increase 104 to and/or remain below the dynamic power supply operating characteristic threshold 74). In cases where the dynamic power supply provides two different power levels (e.g., supplying the higher power 50 at a first time (e.g., 102) and supplying the recovery power at a second time (e.g., 104)), the dynamic power supply may not change from the first power level 50 to the second power level 54 until after a hysteresis time 106 (e.g., 1 minute) has elapsed. This may limit or reduce an amount of back-and-forth communication between the dynamic power supply and the electronic device to increase or optimize efficiency between the devices. Additionally, this may apply to dynamic power supplies that are already at higher temperatures or operating characteristics due to a previous charging session (e.g., unplugging and plugging into a new electronic device).

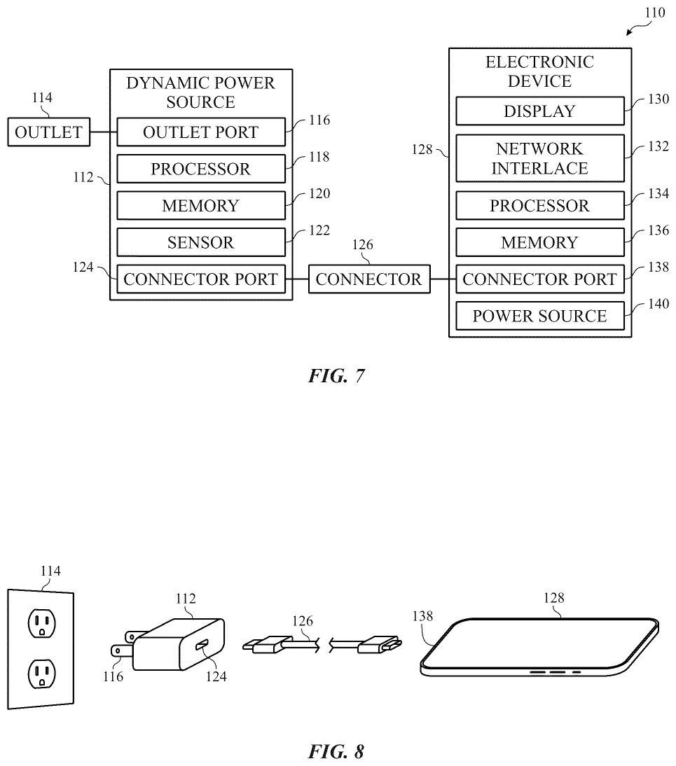

FIG. 7 is a block diagram of a charging system 110 including the dynamic power supply 112, according to embodiments of the present disclosure. In particular, an outlet 114 may provide a connection to an electrical grid, which may supply alternating current (AC). The dynamic power supply 112 may provide the dynamic charging or power 40, or a power that is not constant, as described above. For example, the dynamic power supply 112 may provide a first, higher power 50 (e.g., greater than 5 W, greater than or equal to 20 W, greater than or equal to 30 W, greater than or equal to 50 W, greater than or equal to 60 W, and so on) at a first time, and a second, lower power 54 (e.g., less than or equal to 5 W, greater than 5 W but less than or equal to 20 W, greater than 5 W but less than or equal to 60 W, and so on) at a second time.

The dynamic power supply 112 may include an outlet port 116 that may be coupled to the outlet 114. The outlet port 116 may include any suitable plug to couple to the outlet 114. The dynamic power supply 112 may also include, among other things, one or more processors 118 (collectively referred to herein as a single processor for convenience, which may be implemented in any suitable form of processing circuitry) and memory 120. The various functional blocks shown in FIG. 7 may include hardware elements (including circuitry), software elements (including machine-executable instructions) or a combination of both hardware and software elements (which may be referred to as logic). The outlet port 116, the processor 118, the memory 120, sensor 122, and/or connector port 124 may each be communicatively coupled directly or indirectly (e.g., through or via another component, a communication bus, a network) to one another to transmit and/or receive signals between one another. It should be noted that FIG. 7 is merely one example of a particular implementation and is intended to illustrate the types of components that may be present in the dynamic power supply 112.

By way of example, the dynamic power supply 112 may include any suitable power or charging device, including a power source, a power charger, a power adapter, and other similar devices. It should be noted that the processor 118 and other related items in FIG. 7 may be embodied wholly or in part as software, hardware, or both. Furthermore, the processor 118 and other related items in FIG. 7 may be a single contained processing module or may be incorporated wholly or partially within any of the other elements within the electronic device 128. The processor 118 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 118 may include one or more application processors, one or more baseband processors, or both, and perform the various functions described herein.

In the dynamic power supply 112 of FIG. 7, the processor 118 may be operably coupled with a memory 120 to perform various algorithms. Such programs or instructions executed by the processor 118 may be stored in any suitable article of manufacture that includes one or more tangible, computer-readable media. The tangible, computer-readable media may include the memory 120 to store the instructions or routines. The memory 120 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 118 to enable the dynamic power supply 112 to provide various functionalities.

The dynamic power supply 112 may also include one or more sensors 122 to determine or detect operating characteristics as discussed above. In particular, the sensor 122 may determine temperature, time, current, voltage, power, whether the dynamic power supply is directly (e.g., without any intervening or intermediate devices) coupled or mounted to an electrical or wall outlet (e.g., wall mounted), and so on. As such, the sensor 122 may include one or more of a temperature sensor, a thermistor, an infrared sensor, a thermal sensor, a clock, a timer, a current sensor, a voltage sensor, a resistance sensor, and so on. The dynamic power supply 112 may include a connector port 124 to couple to a connector 126 enabling connection to the electronic device 128. The connector 126 may be any suitable connector that enables connection and/or communication between the dynamic power supply 112 and the electronic device 128, such as a USB cable, including a USB type-A cable, a USB type-B cable, a USB type-C cable, a USB micro-A cable, a USB micro-B cable, a USB lightning cable, a USB mini-A cable, a USB mini-B cable, and so on. As such, the connector port 124 may practice or implement a power delivery or communication standard that is also practiced or implemented by the connector 126, such as a USB standard, including a USB type-A standard, a USB type-B standard, a USB type-C standard, a USB micro-A standard, a USB micro-B standard, a USB lightning standard, a USB mini-A standard, a USB mini-B standard, and so on.

The electronic device 128 may include, among other things, a display 130, a network interface 132, one or more processors 134 (collectively referred to herein as a single processor for convenience, which may be implemented in any suitable form of processing circuitry), memory 136, and a power source 140. The various functional blocks shown in FIG. 7 may include hardware elements (including circuitry), software elements (including machine-executable instructions) or a combination of both hardware and software elements (which may be referred to as logic). The display 130, the network interface 132, the processor 134, the memory 136, the connector port 138, and/or the power source 140 may each be communicatively coupled directly or indirectly (e.g., through or via another component, a communication bus, a network) to one another to transmit and/or receive signals between one another. It should be noted that FIG. 7 is merely one example of a particular implementation and is intended to illustrate the types of components that may be present in the electronic device 128.

By way of example, the electronic device 128 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 128 may include an access point, such as a base station, a router (e.g., a wireless or Wi-Fi router), a hub, a switch, and so on. It should be noted that the processor 134 and the memory 136 may be similar to and/or have similar characteristics as the processor 118 and the memory 120 of the dynamic power supply 112 described above.

The display 130 may facilitate users to view images generated on the electronic device 128. In some embodiments, the display 130 may include a touch screen, which may facilitate user interaction with a user interface of the electronic device 128. Furthermore, it should be appreciated that, in some embodiments, the display 130 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The network interface 132 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 132 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 132 of the electronic device 128 may allow communication over the aforementioned networks (e.g., 5G, Wi-Fi, LTE-LAA, and so forth). The network interface 132 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

The connector port 138 may couple to the connector 126, thus enabling connection to the dynamic power supply 112 via the connector port 124. As such, the connector port 138 may practice or implement a power delivery or communication standard that is also practiced or implemented by the connector 126 and/or the connector port 124, such as a USB standard, including a USB type-A standard, a USB type-B standard, a USB type-C standard, a USB micro-A standard, a USB micro-B standard, a USB lightning standard, a USB mini-A standard, a USB mini-B standard, and so on.

The power source 140 of the electronic device 128 may include any suitable source of power, such as a battery and/or an alternating current (AC) power converter. For example, the power source 140 may include a secondary or rechargeable battery, a lithium-ion battery, a lithium iron phosphate battery, a lithium-ion polymer battery, a nickel-cadmium battery, a nickel-metal hydride battery, a lead-acid battery, and so on. In particular, the power source 140 may be charged by the electrical grid provided by the outlet 114 via the connector port 124 of the dynamic power supply 112, the connector 126, and the connector port 138 of the electronic device 128.

FIG. 8 is a perspective diagram of the charging system 110 of FIG. 7, according to embodiments of the present disclosure. As illustrated, the dynamic power supply 112 may couple to the outlet 114 by its connector port 124, which in turn may couple to a first end of the connector 126. A second end of the connector 126 may couple to the connector port 138 of the electronic device. Once coupled in this manner, the dynamic power supply 112 may charge the power source 140 of the electronic device 128 as described herein.

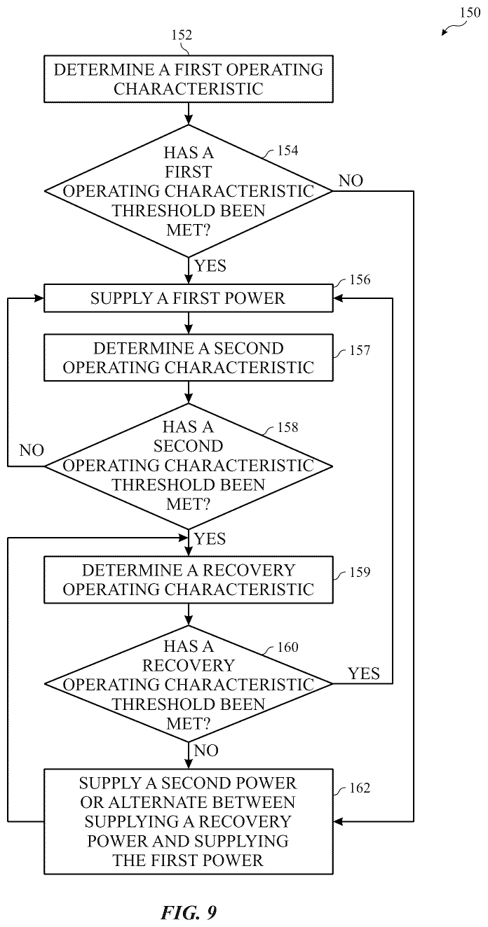

FIG. 9 is a flowchart of a method 150 for dynamically charging the power source 140 of the electronic device 128 using the dynamic power supply 112, according to embodiments of the present disclosure. Any suitable device (e.g., a controller) that may control components of the dynamic power supply 112, such as the processor 118, may perform the method 150. In some embodiments, the method 150 may be implemented by executing instructions stored in a tangible, non-transitory, computer-readable medium, such as the memory 120, using the processor 118. For example, the method 150 may be performed at least in part by one or more software components, such as an operating system of the dynamic power supply 112, one or more software applications of the dynamic power supply 112, and the like. While the method 150 is described using steps in a specific sequence, it should be understood that the present disclosure contemplates that the described steps may be performed in different sequences than the sequence illustrated, and certain described steps may be skipped or not performed altogether.

In process block 152, the processor 118 determines or detects a first operating characteristic (e.g., using a sensor 122 and/or timer of the dynamic power source 112). As discussed above, the first operating characteristic may include temperature, time, current, voltage, power, whether the dynamic power supply is directly (e.g., without any intervening or intermediate devices) coupled or mounted to an electrical or wall outlet (e.g., wall mounted), and so on. For example, the first operating characteristic may include temperature, and, as such, the processor 118 may determine a temperature of the dynamic power supply 112, at an exterior or skin of the dynamic power supply 112, at an interior or circuit of the dynamic power supply 112, at the electronic device 128, of an ambient environment, and so on. As mentioned above, in some embodiments, the processor 118 may determine multiple operating characteristics.

In decision block 154, the processor 118 determines whether a first operating characteristic threshold (e.g., such as the charging temperature threshold 68) has been met. The first operating characteristic threshold may provide a condition for which the dynamic power supply 112 may supply the higher power 50, thus providing fast charging, for a certain period of time (e.g., an initial charge threshold time 70). As discussed above, and as an example, the first operating characteristic threshold may include a temperature of the dynamic power supply 112, such as 25° C., and the processor 118 may determine that the first operating characteristic threshold has been met when the temperature of the dynamic power supply 112 is below or at the charging temperature threshold 68.

If the processor 118 determines that the first operating characteristic threshold has been met, then, at process block 156, the processor 118 supplies a first power (e.g., the higher power 50). In particular, the processor 118 may cause the dynamic power supply 112 to supply the higher power 50 to the power source 140 of the electronic device 128 to fast charge the power source 140. Supplying the first power 50 may correspond to the initial charge period 70 of FIG. 4.

In process block 157, the processor 118 determines or detects a second operating characteristic (e.g., using a sensor 122 and/or timer of the dynamic power source 112). Similar to the first operating characteristic, the second operating characteristic may include temperature, time, current, voltage, power, whether the dynamic power supply is directly (e.g., without any intervening or intermediate devices) coupled or mounted to an electrical or wall outlet (e.g., wall mounted), and so on. The second operating characteristic may be the same or different operating characteristic as the first operating characteristic. As mentioned above, in some embodiments, the processor 118 may determine multiple operating characteristics for the second operating characteristic.

In decision block 158, the processor 118 determines whether a second operating characteristic threshold has been met. For example, where the second operating characteristic is time, the second operating characteristic threshold may include a period of time (e.g., the initial charge period 70 of 15 minutes) that the dynamic power supply 112 may guarantee delivery of the higher power 50, and thus fast charging, when initial conditions (e.g., the first operating characteristic threshold) have been met. In such an example, the second threshold time may enable a 0% to 50% SoC using a 3 A charger cable, such as 15 minutes. In additional or alternative embodiments, second operating characteristic may include temperature, and the second operating characteristic threshold may include a temperature (e.g., the charger temperature threshold 74) at which the dynamic power supply may enter the charger recovery period or time 76.

If the processor 118 determines that the second operating characteristic threshold has been met, then, in process block 159, the processor 118 determines or detects a recovery operating characteristic (e.g., using a sensor 122 and/or timer of the dynamic power source 112). Similar to the first and second operating characteristics, the recovery operating characteristic may include temperature, time, current, voltage, power, whether the dynamic power supply is directly (e.g., without any intervening or intermediate devices) coupled or mounted to an electrical or wall outlet (e.g., wall mounted), and so on. The recovery operating characteristic may be the same or different operating characteristic as the first and/or second operating characteristic. In some embodiments, the processor 118 may determine multiple operating characteristics for the recovery operating characteristic.

At decision block 160, the processor 118 determines whether a recovery operating characteristic threshold has been met. The recovery operating characteristic threshold may enable the dynamic power supply 112 to provide the higher power 50 and/or fast charging for the initial charge threshold 68 and/or the guaranteed time at a next full dynamic power supply cycle 84. Thus, the recovery operating characteristic threshold may include a recovery temperature, time, current, voltage, power, whether the dynamic power supply is directly (e.g., without any intervening or intermediate devices) coupled or mounted to an electrical or wall outlet (e.g., wall mounted), and so on. For example, as discussed above, the recovery operating characteristic threshold may include the recovery time 76. As such, the recovery time 76 may enable the operating characteristic to return to its original level prior to initial charging (e.g., to the initial charge operating characteristic threshold 68). For example, in the case that the first operating characteristic threshold is the temperature of the dynamic power supply 112 being 25° C. 68, the recovery time 76 may enable the temperature of the dynamic power supply 112 to return to 25° C. (e.g., if the dynamic power supply provides the recovery power for at least some of the recovery time 76). In some embodiments, a manufacturer of the dynamic power supply 112 may set the recovery time 76.

If the processor 118 determines that the recovery operating characteristic threshold has not been met, or, referring back to decision block 154, if the processor 118 determines that the first operating characteristic threshold has not been met, then at process block 162, the processor 118 supplies a second power 54 (e.g., the lower power) or alternates between supplying the recovery or low (e.g., nominal, near, or at zero) power and the first power 50, as shown in FIG. 4. Whether the dynamic power supply 112 supplies the second power 54 or alternates between supplying the recovery power and the first power 50 may be set by a manufacturer of the dynamic power supply 112. This may enable the dynamic power supply 112 to maintain the operating characteristic below or at the dynamic power supply operating characteristic threshold 74 (e.g., maintain temperature of the dynamic power supply 112 below or at X° C.). Moreover, it should be understood that the dynamic power supply 112 may, in some embodiments, supply the first power 50 at a first time, supply the second power 54 at a second time, and/or supply the recover power at a third time, all to maintain the operating characteristic below or at the dynamic power supply operating characteristic threshold 74. For example, as shown in FIG. 5, the dynamic power supply 112 may supply the first power 50 at a first time and the second power 54 at a second time, as the temperature 90 of supplying the first power 50 and the second power 54 over time is less than the dynamic power supply operating characteristic threshold 74 (“Charger Temp Limit X° C.”). The processor 118 may then return to decision block 160 to determine whether the recovery time has been exceeded.

If the processor 118 determines that the recovery operating characteristic threshold has been met, then the processor 118 returns to process block 156 to supply the first power 50. Indeed, as the recovery operating characteristic threshold may enable the dynamic power supply 112 to provide the higher power 50 and/or fast charging for the initial charge threshold 68 and/or the guaranteed time at a next full dynamic power supply cycle 84. As such, the processor 118 may begin the next full dynamic power supply cycle 84 as discussed in FIG. 4 above.

Similarly, and referring back to decision block 158, if the processor 118 determines that the second operating characteristic threshold has not been met, then the processor 118 returns to process block 156 to supply the first power 50. That is, because the second operating characteristic threshold (e.g., a time period to supply the first power 50, a temperature of the dynamic power supply 112 for which it is acceptable to continue supplying the first power 50) has not been met, the processor 118 may continue supplying the first power 50.

As mentioned above, the processor 118 may enforce a hysteresis time (e.g., 1 minute) prior to switching from one power level to another, as shown in FIG. 6. For example, when alternating between supplying the recovery power and supplying the first power 50 in process blocks 162 and/or 164, the processor 118 may determine whether the hysteresis time has elapsed since the time it changed from supplying the recovery power to supplying the first power 50, or vice versa. If not, then the processor 118 may not switch to providing the other power level, and instead wait until the hysteresis time elapses. Once the processor 118 determines that the hysteresis time elapses, then it may switch to providing the other power level.

In this manner, the processor 118 of the dynamic power supply 112 may dynamically charge the power source 140 of the electronic device 128 using the method 150. As such, the dynamic power supply 112 may supply power at different power levels based on an operating characteristic. In some embodiments, each period of different power delivery scheme may be triggered based on a detected temperature of the dynamic power supply 112 (e.g., by the sensor 122 in the form of a temperature sensor), a time or time period of providing one or more power levels by the dynamic power supply (e.g., as determined by the sensor 122 in the form of a clock or timer), and so on.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A device comprising:
an outlet port;
a connector port;
one or more sensors configured to determine a first operating characteristic and a second operating characteristic; and
processing circuitry coupled to the outlet port, the connector port, and the one or more sensors, wherein the processing circuitry is configured to supply a first power at the connector port based on the first operating characteristic and supply a second power at the connector port based on the second operating characteristic.

2. The device of claim 1, wherein the first operating characteristic comprises temperature.

3. The device of claim 2, wherein the processing circuitry is configured to supply the first power based on the temperature being less than or equal to a threshold temperature.

4. The device of claim 1, wherein the outlet port is configured to couple to an outlet that supplies alternating current from an electrical grid.

5. The device of claim 1, wherein the connector port is configured to couple to a connector, and the connector is configured to couple to an electronic device comprising a power source, wherein the processing circuitry is configured to supply the first power and the second power to charge the power source.

6. The device of claim 5, wherein the connector comprises a Universal Serial Bus (USB) type-C cable.

7. A method comprising:
determining, via one or more sensors of a dynamic power supply, a first operating characteristic;
supplying, via processing circuitry of the dynamic power supply, a first power to a power source of an electronic device based on the first operating characteristic;
determining, via the one or more sensors, a second operating characteristic; and
supplying, via the processing circuitry, a second power to the power source based on the second operating characteristic.

8. The method of claim 7, wherein the first power is greater than the second power.

9. The method of claim 7, wherein the first operating characteristic comprises temperature.

10. The method of claim 7, wherein the second operating characteristic comprises time.

11. The method of claim 7, comprising:
determining, via the one or more sensors, a recovery operating characteristic; and
supplying, via the processing circuitry, the first power to the power source based on the recovery operating characteristic.

12. The method of claim 11, wherein supplying, via the processing circuitry, the first power to the power source based on the recovery operating characteristic occurs after supplying, via the processing circuitry, the second power to the power source based on the second operating characteristic.

13. The method of claim 11, wherein supplying, via the processing circuitry, the second power to the power source occurs after a hysteresis time period has elapsed from supplying, via the processing circuitry, the first power.

14. The method of claim 11, comprising providing an indication of the first power and the second power to the electronic device.

15. Tangible, non-transitory, computer-readable media configured to store instructions that cause processing circuitry of a dynamic power supply to:
supply a first power based on a first operating characteristic of the dynamic power supply meeting a first threshold; and
supply a second power based on a second operating characteristic of the dynamic power supply meeting a second threshold.

16. The tangible, non-transitory, computer-readable media of claim 15, wherein the first power is greater than 5 watts, and wherein the second power is less than or equal to 5 watts.

17. The tangible, non-transitory, computer-readable media of claim 15, wherein the first operating characteristic comprises temperature, the first threshold comprises a threshold temperature, and the instructions cause the processing circuitry to supply the first power based on the temperature of the dynamic power supply being less than or equal to the threshold temperature.

18. The tangible, non-transitory, computer-readable media of claim 17, wherein the second operating characteristic comprises the temperature, the second threshold comprises a second threshold temperature, and the instructions cause the processing circuitry to supply the second power based on the temperature of the dynamic power supply being greater than or equal to the second threshold temperature.

19. The tangible, non-transitory, computer-readable media of claim 17, wherein the second operating characteristic comprises time, the second threshold comprises a threshold time period, and the instructions cause the processing circuitry to supply the second power based on the threshold time period elapsing.

20. The tangible, non-transitory, computer-readable media of claim 15, wherein the instructions cause the processing circuitry to transmit an indication that the second power will be supplied prior to supplying the second power.
